(19) United States
(12) Patent Application Publication
(10) Pub. No.: US 2014/0014419 A1
(43) Pub. Date: Jan. 16, 2014

(54) POWER SUPPLY DEVICE, VEHICLE AND ELECTRIC POWER STORAGE DEVICE INCLUDING POWER SUPPLY DEVICE, AND BATTERY CELL

(71) Applicants: Kazuhiro FUJII, Taka-cho (JP); Takashi Seto, Kakogawa-shi (JP); Mitsutoshi TAJIMA, Kasai-shi (JP)

(72) Inventors: Kazuhiro FUJII, Taka-cho (JP); Takashi Seto, Kakogawa-shi (JP); Mitsutoshi TAJIMA, Kasai-shi (JP)

(21) Appl. No.: 13/549,853

(22) Filed: Jul. 16, 2012

(51) Int. Cl. H01M 4/00; H02J 7/00; B60K 1/04; H01R 43/16

(52) U.S. Cl. 180/65.1; 429/94; 29/874; 320/134

(57) ABSTRACT

A power supply device includes a battery block that includes battery cells, and fasteners that securely hold the battery block. Each of the cells includes an exterior container, a wound electrode, a sealing plate, and a connector. The container has a rectangular exterior shape, and opens on one face. The electrode includes electrode and separator sheets that are wound so that the electrode and separator sheets are alternately superposed on each other. The sealing plate closes the opening of the container. The connector is fastened to the sealing plate and electrically connected to the electrode. The electrode has a thickness smaller than the opening width of the container. The electrode is suspended by connectors so that the electrode is spaced away from the bottom of the container. The fastener securely holds the battery block so that the electrodes are interposed between the interior surfaces of the containers.

### BACKGROUND OF THE INVENTION

1. Field of the Invention

The present invention mainly relates to a power supply device that can be used as large current power supplies for electric motor for driving cars such as hybrid car and electric vehicle, and as electric power storages for home use and manufacturing plants, and a battery cell that can be used for this type of power supply device. The present invention also relates to a vehicle and an electric power storage including this power supply device.

2. Description of the Related Art

Power supply devices such as battery packs for vehicles are required which can supply high electric power. In order to accommodate a number of battery cells in limited space, the high power supply devices generally include rectangular batteries, which can efficiently occupy space. The rectangular battery includes a wound electrode, and a rectangular exterior container that accommodates the wound electrode, and a sealing plate that seals the exterior container. In a high power supply device, a number of rectangular batteries are arranged side by side with electrically insulating members such as resin spacers being interposed between the rectangular battery cells. After the battery cells and the spacers are alternately arranged, the battery cells and the spacers are securely held by bind bars or the like so that a battery block is provided.

For example, Laid-Open Patent Publication Nos. JP 2012-38,703 A, and JP 2010-287,530 A disclose the construction of a battery cell used for the aforementioned type power supply device.

JP 2012-38,703 A discloses a battery cell 340 that includes a wound electrode 3434, and an exterior container 3410. Parts of the surface of the wound electrode 3434 are in contact with the interior surface of the exterior container 3410 when the wound electrode 3434 is inserted into the exterior container 3410. The wound electrode is fastened to the bottom surface of the sealing plate through a current-collector-connecting plate. In addition, an output terminal is arranged on the surface side of the sealing plate. The wound electrode is electrically connected to the output terminal through the current collector connection plate. The wound electrode is suspended from the sealing plate by the current collector connection plate, and is held in the exterior container. However, in this suspension structure, since the wound electrode is held only by the current collector connection plate, for example, if the battery cell is subjected to vibration, a large stress may be applied to the current-collector-connecting plate.

The present invention is aimed at solving the problem. It is a main object of the present invention is to provide a power supply device, a battery cell, power-supply-device separator, and power-supply-device-equipped vehicle and electric power storage that can improve workability in battery cell assembling.

### SUMMARY OF THE INVENTION

To achieve the above object, a power supply device according to an aspect of the present invention includes a battery block that includes a plurality of battery cells, and a fastening member that securely holds the battery block. Each of the battery cells includes an exterior container, a wound electrode, a sealing plate, and a current-collector-connecting portion. The exterior container has a rectangular exterior shape, and opens on at least one face. The wound electrode includes electrode and separator sheets that are wound so that the electrode and separator sheets are alternately superposed on each other. The sealing plate closes the opening of the exterior container with the wound electrode being accommodated in this exterior container. The current-collector-connecting portion is fastened to the sealing plate and electrically connected to the wound electrode. The wound electrode has a thickness smaller than the opening width of the exterior container so that the wound electrode can be inserted into the exterior container. The current-collector-connecting portion suspends the wound electrode so that the bottom side of the wound electrode is spaced away from the bottom interior surface of the exterior container. The fastening member securely holds the battery block so that the wound electrodes, which are accommodated in the exterior containers, are interposed between the interior surfaces of the exterior containers of the battery cells.

According to this construction, it is possible to easily insert the wound electrode into the exterior container in assembling. In addition, since the wound electrode can be held and interposed between the interior surfaces of the exterior container by the fastening member after assembling, the wound electrodes can be stably held in the battery cells. Therefore, it is possible to improve the reliability of the power supply device.

A method according to another aspect of the present invention is a method for producing a power supply device including a battery block that includes a plurality of battery cells, and a fastening member that securely holds the battery block. In this method, an exterior container is formed which a rectangular exterior shape, and opens on at least one face. A wound electrode is formed which including electrode and separator sheets to be wound so that the electrode and separator sheets are alternately superposed on each other. A sealing plate is formed which can hold current-collector-connecting portions to be electrically connected to the wound electrode. The wound electrode is wound so that the wound electrode has a thickness smaller than the opening width of the exterior container. The current-collector-connecting portions are fastened onto current-collecting tabs that are provided on the both sides of the wound electrode. The wound electrode is inserted into the exterior container through the opening of the exterior container. The wound electrode is suspended from the sealing plate so that the bottom side of the wound electrode is spaced away from the bottom interior surface of the exterior container. An electrolyte is injected into the exterior container so that the battery cell is produced. The produced battery cell is charged to a predetermined SOC so that the external surface of the wound electrode comes in direct or indirect contact with the interior surface of the exterior container. The battery block is securely held by the fastening member so that the wound electrodes are interposed between the interior surfaces of the exterior containers.

According to this method, it is possible to easily insert the wound electrode into the exterior container in assembling. In addition, since the wound electrode can be held and interposed between the interior surfaces of the exterior container by the fastening member after assembling, the wound electrodes can be stably held in the battery cells. Therefore, it is possible to improve the reliability of the produced power supply device.

The above and further objects of the present invention as well as the features thereof will become more apparent from the following detailed description to be made in conjunction with the accompanying drawings.

### BRIEF DESCRIPTION OF THE DRAWINGS

FIG. 1 is a perspective external view showing a battery cell according to a first embodiment of the present invention;

FIG. 2A is a front cross-sectional view showing the battery cell according to the first embodiment of the present invention;

FIG. 2B is a vertical cross-sectional view of the battery cell taken along the line IIB-IIB;

FIG. 2C is a horizontal cross-sectional view of the battery cell taken along the line IIC-IIC;

FIG. 3 is an exploded front view showing an exterior container, and a sealing plate onto which a wound electrode is fastened;

FIG. 4 is a perspective view showing the wound electrode covered by an electrically insulating cover;

FIG. 5 is a cross-sectional view showing the exterior container filled with an electrolyte;

FIG. 6 is an exploded perspective view showing a current-collector-connecting portion, and the wound electrode to be fastened to the current-collector-connecting portion;

FIG. 7A is a perspective view showing the current collector electrode plate;

FIG. 7B is a perspective view showing the current collector electrode plate with tab holding portions being bent from the horizontal orientation shown in FIG. 7A;

FIG. 8 is a developed view of the electrically insulating cover;

FIG. 9 is an exploded perspective view of the battery block;

FIG. 10A is a cross-sectional view showing the battery cells that are arranged side by side;

FIG. 10B is a schematic cross-sectional view showing the battery cells shown in FIG. 10A that are securely held;

FIG. 11 is a schematic plan view showing the battery cell with the part of surface that is pressed by a battery press area of the spacer;

FIG. 12 is a block diagram showing an exemplary hybrid car that is driven by an internal-combustion engine and an electric motor, and includes the power supply device;

FIG. 13 is a block diagram showing an exemplary electric vehicle that is driven only by an electric motor, and includes the power supply device;

FIG. 14 is a block diagram a power storage type power supply device to which the present invention is applied; and

FIG. 15 is a cross-sectional view showing a known battery cell.

### DETAILED DESCRIPTION OF THE EMBODIMENT(S)

According to an exemplary power supply device, a battery cell includes an electrically insulating cover that is arranged between a wound electrode and an exterior container, and formed from an electrically insulating film. A fastening member securely holds a battery block so that the electrically insulating covers come in contact with the wound electrode contacts.

According to another exemplary power supply device, current-collecting tabs are provided on the both sides of the wound electrode. The current-collecting tabs are fastened to current-collector-connecting portions so that the wound electrode is suspended. The current-collector-connecting portion is orientated in parallel to the main surface of the exterior container.

According to this construction, the wound electrode can be fastened to the back surface of a sealing plate through the current-collector-connecting portion.

According to another exemplary power supply device, the wound electrode can expand and come in direct or indirect contact with the interior surface of the exterior container after the battery cell is repeatedly charged/discharged.

According to this construction, the wound electrode can be smoothly inserted into the exterior container, while the wound electrode can be brought into direct or indirect contact with the interior surface of the exterior container by using the expansion property of the wound electrode in use after inserted into the exterior container.

According to another exemplary power supply device, spacers are provided which are interposed between the battery cells so that the battery cells are pressed by the spacers. This battery press area of each of the spacers overlaps the part of the battery cell where the wound electrode is arranged.

According to this construction, the wound electrode can be reliably held, while it is possible to reduce a stress that is applied to members of the battery cell other than the wound electrode.

According to another exemplary power supply device, spacers are further provided which are interposed between the battery cells. The spacer does not overlap the part of the battery cell where the sealing plate is arranged.

According to this construction, after the battery cells are arranged side by side so that the spacers are interposed between the battery cells, when the battery cells and the spacers are securely held by the fastening member, the spacers can press not the sealing plates but the wound electrodes that are suspended from the sealing plates. As a result, the wound electrodes can be held by the interior surfaces of the exterior containers, which are pressed by the spacers.

According to another exemplary power supply device, each of battery cells includes a current cutoff element that cuts off the output current if an abnormality occurs inside the exterior container. The current cutoff element is arranged inside the exterior container between the sealing plate and the wound electrode. The power supply device further comprises a spacer that is interposed between the battery cells. The spacer does not overlap the part of the battery cell where the current cutoff element is arranged.

According to this construction, it is possible to prevent that an undesirable stress is applied to the current cutoff element when the battery block is securely held by the fastening member. Therefore, it can be ensured that the current cutoff element properly operates.

A battery cell according to the present invention is charged to a predetermined SOC whereby preventing this battery cell from being over-discharged during storage. The battery cell includes an exterior container, a wound electrode, a sealing plate, and current-collector-connecting portions. The exterior container has a rectangular exterior shape, and opens on at least one face. The wound electrode includes electrode and separator sheets that are wound so that the electrode and separator sheets are alternately superposed on each other. The sealing plate closes the opening of the exterior container with the wound electrode being accommodated in this exterior container. The current-collector-connecting portions are fastened to the sealing plate and electrically connected to the wound electrode. The wound electrode has a thickness smaller than the opening width of the exterior container so that the wound electrode can be inserted into the exterior container. The current-collector-connecting portions suspend the wound electrode so that the bottom side of the wound electrode is spaced away from the bottom interior surface of the exterior container. The external surface of the wound electrode is brought in indirect contact with the interior surface of the exterior container with an electrically insulating cover being interposed between the interior surface of the exterior container and the external surface of the wound electrode after the battery cell is charged to the predetermined SOC.

According to this construction, it is possible to easily insert the wound electrode into the exterior container in assembling. In addition, since the wound electrode can be held and interposed between the interior surfaces of the exterior container by the fastening member after assembling, the wound electrodes can be stably held in the battery cells. Therefore, it is possible to improve the reliability of the power supply device.

A vehicle according to the present invention includes the aforementioned power supply device. The vehicle includes a driving electric motor, a vehicle body, and wheels. The driving electric motor is supplied with the electric power from this power supply device. The vehicle body accommodates the power supply device and the electric motor. Wheels are driven by the electric motor for vehicle traveling.

An electric power storage device according to the present invention includes the aforementioned power supply device. The electric power storage device further includes a power supply controller that controls charging/discharging operation of the power supply device. The power supply device can be charged with electric power from the outside by the power supply controller. The power supply device controls charging operation of the power supply device when the power supply device is charged with electric power from the outside.

The following description will describe embodiment according to the present invention with reference to the drawings.

### (Battery Cell 1)

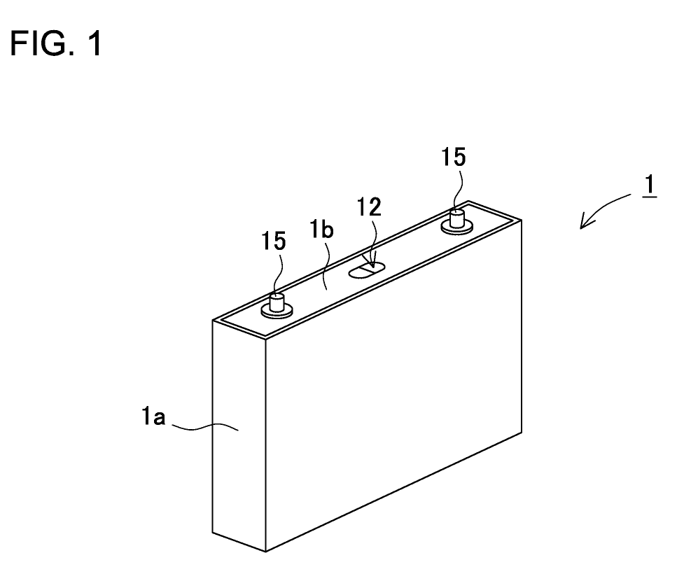

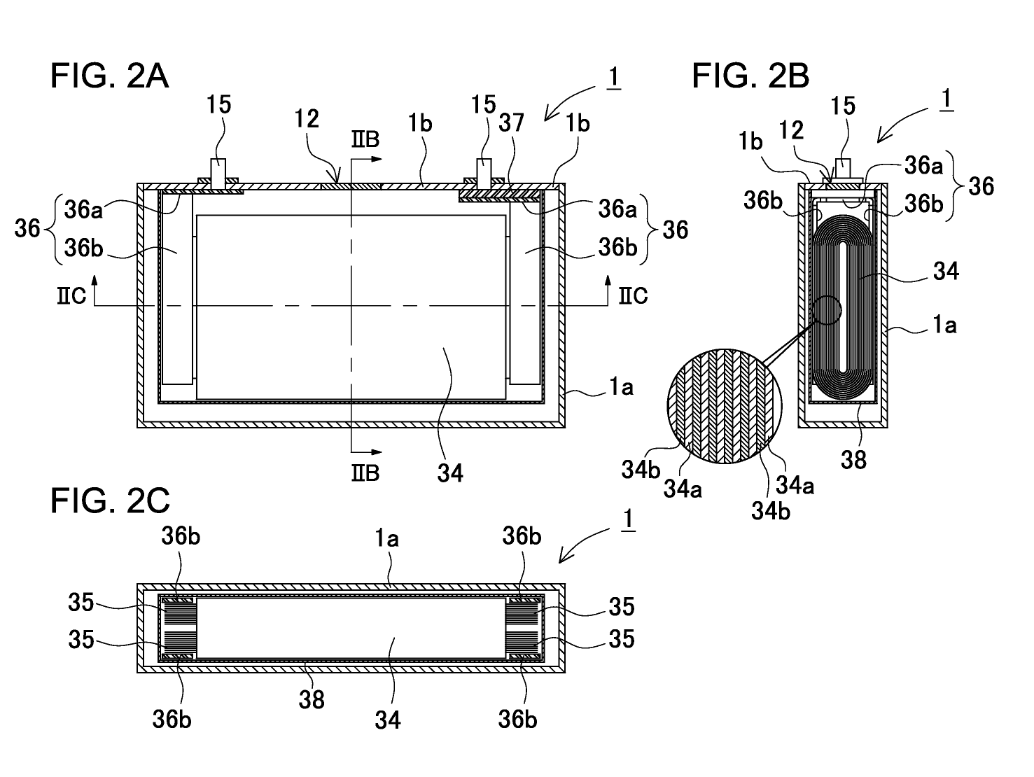

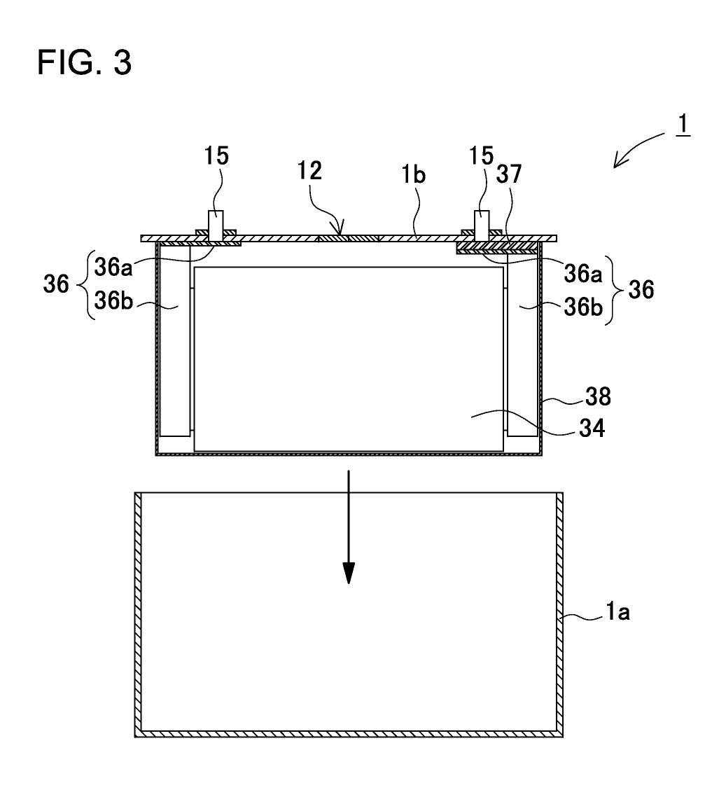

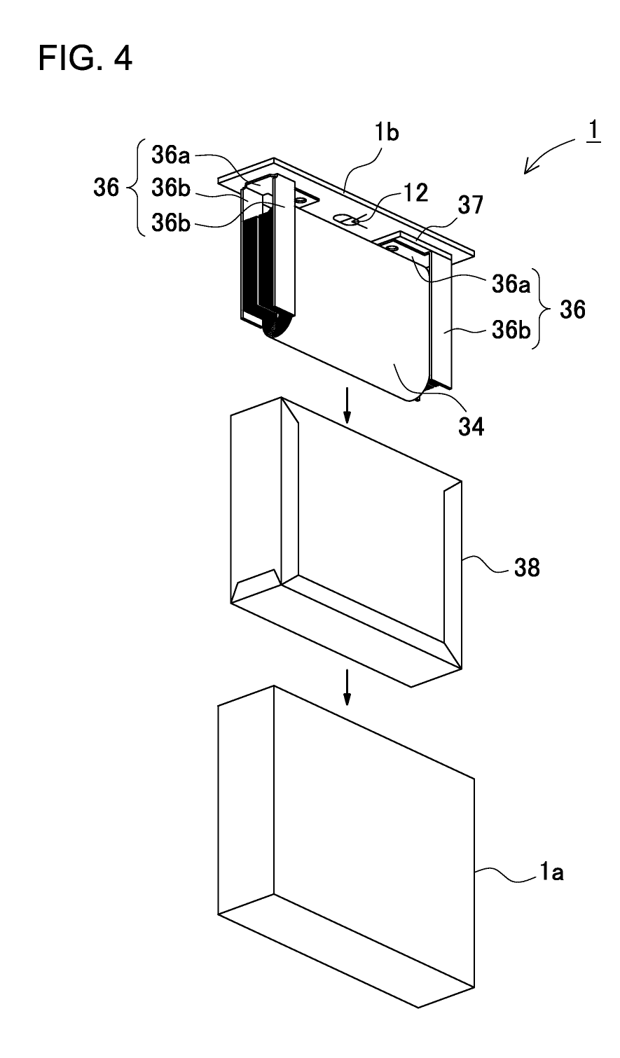

FIG. 1 is a perspective view showing a battery cell 1 according to a first embodiment of the present invention. The battery cell 1 has a rectangular box exterior shape. The thickness of the battery cell 1 is smaller than the width. FIGS. 2A to 2C are cross-sectional views showing the battery cell 1. FIG. 3 is an exploded front view showing an exterior container 1a, and a sealing plate 1b onto which a wound electrode 34 is fastened. FIG. 4 is a perspective view showing the wound electrode 34 covered by an electrically insulating cover 38. The illustrated battery cell 1 includes the exterior container 1a, the wound electrode 34, the electrically insulating cover 38, and the sealing plate 1b. The exterior container 1a forms the exterior shape of the battery cell 1. The wound electrode 34 is accommodated in the exterior container 1a. The electrically insulating cover 38 covers the periphery of the wound electrode 34. The sealing plate 1b closes the opening of the exterior container 1a with the wound electrode 34 being accommodated in this exterior container 1a.

(Exterior Container 1a)

The exterior container 1a has a box shape that opens on one face. The battery cell according to the embodiment shown in of FIGS. 3, 4, etc., the upper face of the rectangular exterior container 1a is opened. This opening is airtightly closed by the sealing plate 1b. The exterior container 1a is a metal case having good thermal conductivity. For example, the exterior container can be formed from an aluminum plate by drawing.

(Sealing Plate 1b)

The sealing plate 1b has a size that allows the sealing plate 1b to close the opening of the exterior container 1a. In the battery cell according to the embodiment shown in of FIG. 1, etc., the sealing plate is formed of a rectangular plate material. The sealing plate 1b includes a pair of output terminals 15 through which the output power of the battery cell 1 is supplied. In addition, the sealing plate 1b has an opening 12 of a safety valve that can open when the pressure in the exterior container 1a exceeds a predetermined value. In the battery cell according to the embodiment shown in of FIG. 1, the opening 12 of the safety valve is arranged at the center of the sealing plate 1b, while the output terminals 15 are arranged on the right and left sides of the sealing plate 1b. The sealing plate 1b is fastened to the exterior container 1a by laser welding, or the like. The current-collector-connecting portion 36 for fastening the wound electrode 34 is fastened to the bottom surface of the sealing plate, i.e., the interior surface of the exterior container 1a.

### (Wound Electrode 34)

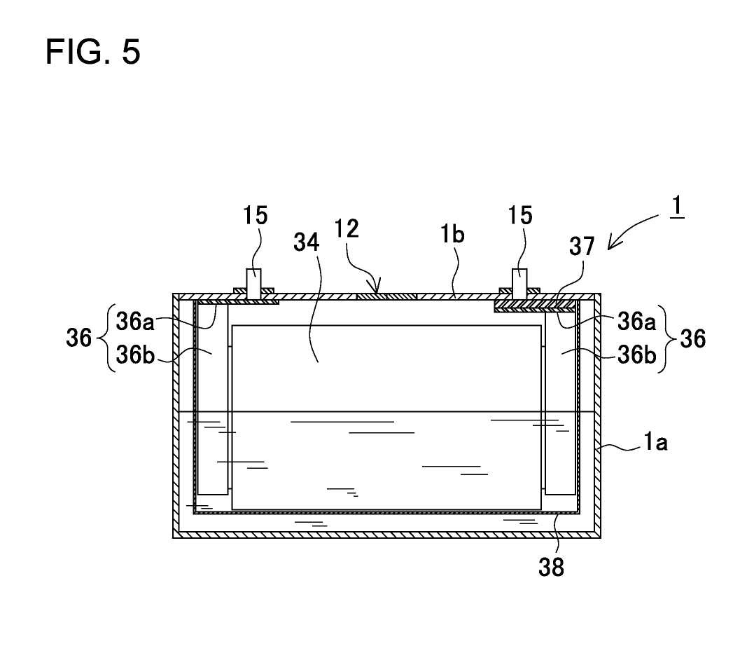

The wound electrode includes positive and negative electrodes 34a that are alternately superposed on each other, and are then wound. Electrically insulating porous separator sheets 34b are interposed between the positive and negative electrode sheets 34a as shown in the enlarged view of FIG. 2B. Thus, it is possible to allow ions to move through the porous separator sheet, and additionally to prevent that the positive and negative electrode sheets 34a come in direct contact with each other. After the thus-constructed wound electrode 34 is accommodated in the exterior container 1a, the wound electrode 34 is impregnated with an electrolyte as shown in FIG. 5. As a result, metal ions can move, which in turn allows an electric current to flow, in other words, the battery cell can be charged/discharged. When the exterior container 1a is filled with the electrolyte, it is not necessary to fully fill the exterior container with the electrolyte, but it is preferable that the exterior container be filled a suitable amount of electrolyte smaller than the amount that fully fills the exterior container. Even in the case where the exterior container is not fully filled with the electrolyte, battery can operate when the porous separator sheets hold electrolyte between the electrode sheets 34a of the wound electrode 34. In this case, it is possible to reduce the manufacturing cost. Also, in the case where the exterior container is filled with an excess of electrolyte, if a pressure or temperature in the exterior container becomes high so that the safety valve opens, the liquid in the exterior container may be discharged through the safety valve. For this reason, it is more preferable to adjust the amount of electrolyte so that the electrolyte level reach roughly the midpoint of the exterior container or smaller than this midpoint.

It is preferable that the wound electrode 34 is suspended so that the bottom side of the wound electrode 34 is spaced away from the bottom interior surface of the exterior container 1a when the wound electrode 34 is accommodated in the exterior container 1a. According to this construction, even if the dimensional deviation of the current-collector-connecting portions is relatively large, it is possible to prevent that the wound electrode 34 comes in contact with the bottom interior surface of the exterior container 1a when the wound electrode 34 is accommodated in the exterior container 1a. If the wound electrode 34 comes in contact with the bottom interior surface of the exterior container 1a, the sealing plate cannot be properly fitted in the exterior container, which may cause adverse influences on sealing plate welding.

### (Current-Collector-Connecting Portion 36)

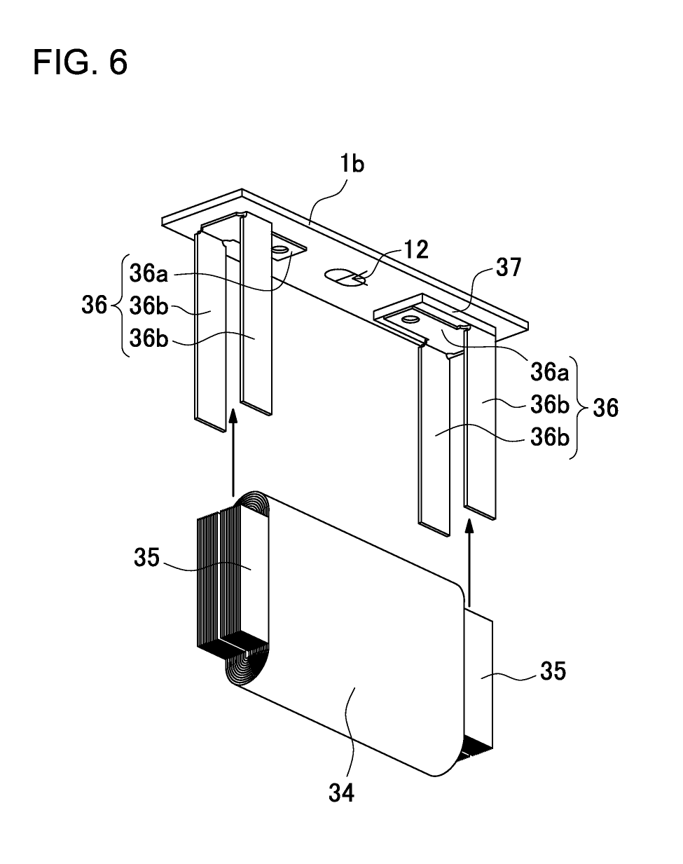

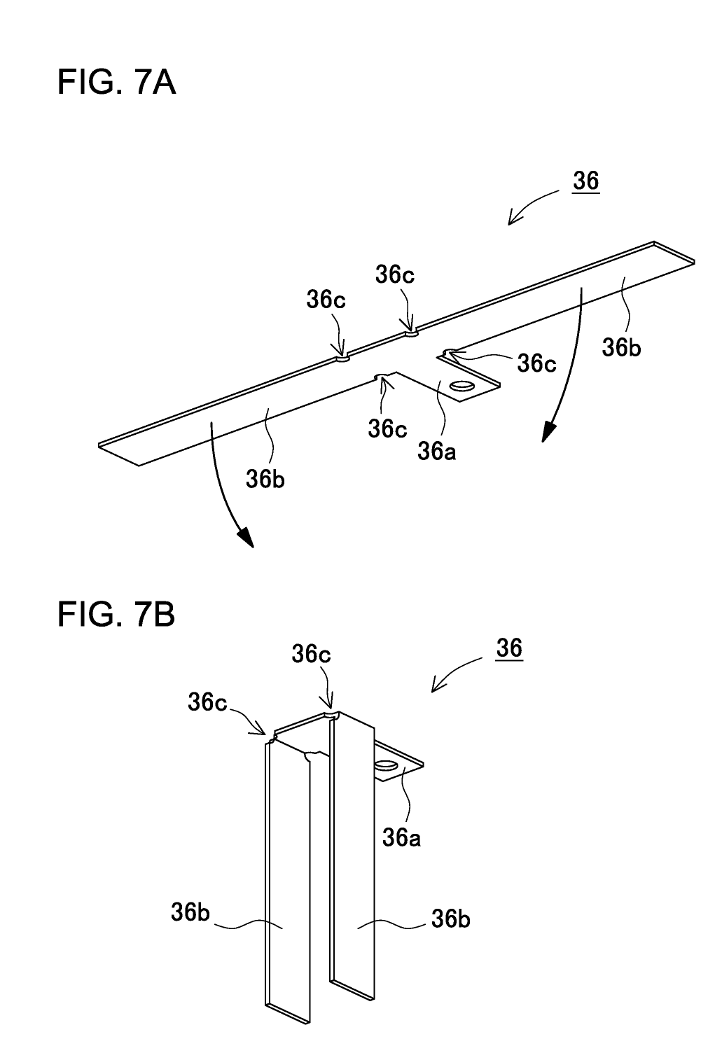

The current-collector-connecting portions 36 electrically connect the wound electrode 34 to the output terminals 15. As a result, an electric current that flows through the wound electrode 34 can be supplied to the outside. Also, when electric power is supplied to the wound electrode 34 when the battery cell is charged, the battery cell can store the electric power through the movement of metal ions. In addition, the current-collector-connecting portions 36 serve to physically suspend the wound electrode 34 inside the exterior container 1a. As shown in a perspective view of FIG. 7A, the current collector electrode plate can be first formed in a roughly T exterior shape. In addition, the current-collector-connecting portion has a sealing plate holding portion 36a as a center part of the current-collector-connecting portion, and tab holding portions 36b. The sealing plate holding portion 36a can be fastened to the sealing plate 1b. The tab holding portions 36b extend rightward and leftward from the center part of the current-collector-connecting portion. The tab holding portions 36b can hold a current-collecting tab 35 of the wound electrode 34. This current collector electrode plate is then bent into a roughly rectangular U shape, as shown in the perspective view of FIG. 7B, by bending the sealing plate holding portions 36a at the boundary between the sealing plate holding portions 36a and the tab holding portion 36b. Also, in order that the tab holding portions 36b can be easily bend, the current-collector-connecting portion has bending cutout portions 36c that are formed at the boundaries between of the sealing plate holding portion 36a and the tab holding portions 36b. Instead of the bending cutout portions, thinner portions may be formed at the boundaries between of the sealing plate holding portion and the tab holding portions. The tab holding portions 36b are bent into substantially parallel orientation so that the tab holding portions 36b are opposed to each other. As shown in an exploded perspective view of FIG. 6, the current-collecting tab 35 is interposed and held between the tab holding portions 36b.

According to this arrangement, the current-collector-connecting portions 36 for suspending the wound electrode 34 can be efficiently accommodated in the exterior container 1a. That is, since the thickness of the current-collecting tab 35 can be smaller than the wound electrode 34, although the tab holding portions 36b are superposed on the surfaces of the current-collecting tab 35, it is not necessary to increase the thickness of the exterior container. For this reason, the wound electrode 34 can be fastened without increasing the external shape of the battery cell.

In addition, the sealing plate holding portion 36a has an opening for receiving the output terminal 15. As shown in FIG. 6, two current-collector-connecting portions 36 are fastened to parts of the back side of the sealing plate 1b close to the side ends of the sealing plate 1b. Also, the sealing plate 1b has openings. When the sealing plate holding portions 36a are fastened to the sealing plate 1b by welding, or the like, the openings of the sealing plate holding portions 36a agree with the openings of the sealing plate 1b so that the output terminals 15 are inserted to these openings.

### (Current Cutoff Element 37)

A current cutoff element 37 can be arranged between one of the current-collector-connecting portions 36, and the sealing plate 1b. The current cutoff element 37 can cut off the output power of the battery cell if an abnormality occurs inside the exterior container. For example, when a pressure in the battery cell exceeds a predetermined value, the current cutoff element can electrically disconnect the output terminal 15 from the current-collector-connecting portion 36. A CID (Current Interrupt Device), or the like, can be suitably used as the current cutoff element 37. The CID can activate in accordance with pressure. The length of the tab holding portion 36b of the current-collector-connecting portion 36 that is arranged on the current cutoff element 37 is reduced by the thickness of the current cutoff element 37 from the length of the tab holding portion 36b of another current-collector-connecting portion 36 that is not arranged on the current cutoff element 37.

In the battery cell according to the embodiment shown in of FIG. 2A, although the current cutoff element 37 is arranged on current-collector-connecting portion 36 on the right side (positive terminal side), the current cutoff element can be arranged on the left side (negative terminal side). Alternatively, the current cutoff elements may be arranged on both the current-collector-connecting portions.

### (Electrically Insulating Cover 38)

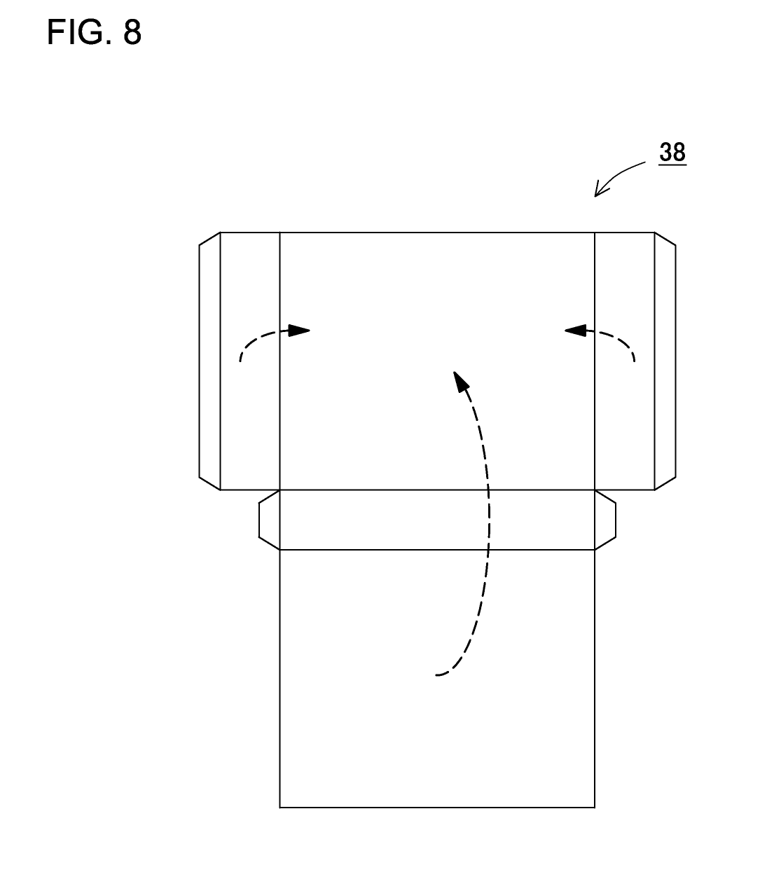

The electrically insulating cover 38 is interposed between the wound electrode 34 and the exterior containers 1a with the wound electrode 34 being fastened to the sealing plate 1b by the current-collector-connecting portions 36. Since the wound electrode 34 and the current-collector-connecting portions 36 are electrically insulated from the exterior container 1a by the electrically insulating cover 38, even in the case where the exterior container 1a is formed of metal, it possible to prevent that an unintentional short circuit occurs between the interior surface of the metal exterior container 1a, and the wound electrode 34 or the current-collector-connecting portion 36. In the battery cell according to the embodiment shown in FIG. 4, the electrically insulating cover 38 covers the exterior surfaces of the wound electrode 34, which is fastened to the sealing plate 1b by the current-collector-connecting portions 36. As shown in the developed view of FIG. 8, the electrically insulating cover 38 according to this embodiment is constructed from an electrically insulating sheet material that has a predetermined shape. The sheet material is folded into a bag shape. The bag-shaped electrically insulating cover 38 covers the external surfaces of the wound electrode 34, and the like. Alternatively, an electrically insulating cover that is previously formed into a bag shape can be used.

### (Battery Block 10)

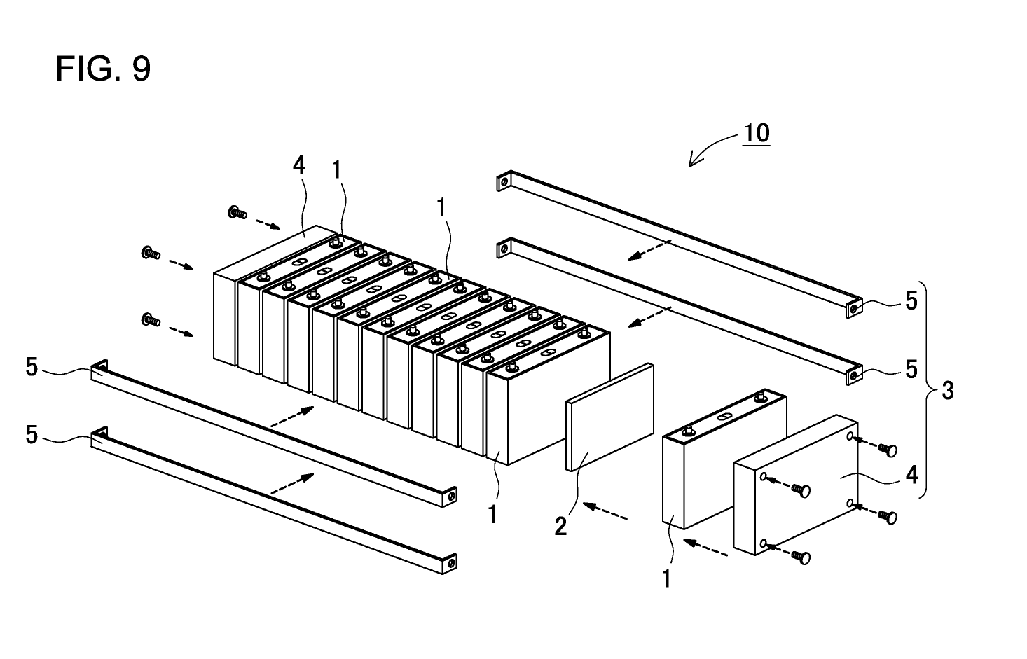

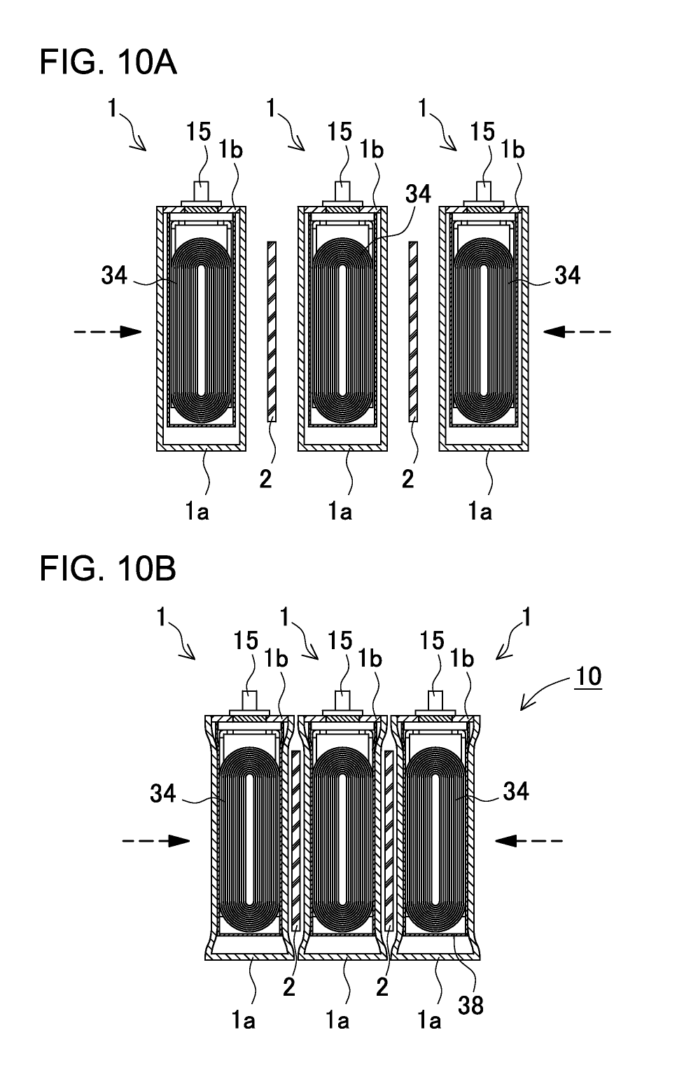

In the case where the aforementioned battery cells are connected to each other in series or in parallel, a large capacity and high output power supply device can be constructed. As shown in FIGS. 10A to 10B, a battery block 10 is constructed of a plurality of battery cells 1 that are arranged side by side. Each of the battery cells 1 includes the wound electrode 34 that are accommodated in the exterior container. FIG. 9 is an exploded perspective view showing an exemplary battery block. In the illustrated battery block, electrically insulating spacers are interposed between battery cells 1 so that the battery cells adjacent to each other are electrically insulated from each other. The spacers are not necessarily provided for electric insulation between battery cells. For example, the exterior container of the battery cell can be wrapped with an electrically insulating film. Alternatively, the battery block may have the electrically insulating films and the spacers.

### (Fastening Member 3)

The power supply device shown in FIG. 9 includes a pair of end plates 4 and bind bars 5 as fastening member 3. The end plates 4 coupled to each other by the bind bars 5. The end plates 4 are arranged on the both end surfaces of the battery block. The bind bar 5 straddles the pair of end plates 4. After the battery block is pressed in the side-by-side arrangement direction of the battery cells, the bind bars 5 are fastened to the end plates 4. Thus, the bind bars 5 hold the battery cells of the battery block in a pressed state. As a result, it is possible to suppress expansion of the battery cells. For this reason, when the wound electrode is in contact with the exterior container, the wound electrode can be interposed and held between the interior surfaces of the exterior container by a fastening force of the bind bar 5. As a result, it is possible to reduce a stress that is applied to the current-collector-connecting portions, which hold the wound electrode.

### (Spacer 2)

In the case where the spacers 2 are interposed between battery cells 1 when the battery block is securely held, it is preferable that the spacer 2 press not the entire surface side of the exterior container of the battery cell 1 but parts of the exterior container other than the peripheral parts of the surface side of the exterior container. If the entire surface side of the exterior container is pressed, an excess stress may be applied to the corner parts of the exterior container, which in turn may cause deformation of the battery cell. In particular, if the part of the exterior container corresponding to the sealing plate is pressed, the welding part between the sealing plate and the exterior container may be damaged. For this reason, the spacer 2 is designed so that a battery press area PA of the spacer 2 does not overlap the part of the exterior container 1a corresponding to the sealing plate 1b when the spacer 2 is sandwiched between the battery cells 1. The battery press area PA is a part of the spacer 2 that presses the exterior container 1a.

In addition, it is preferable that the battery press area be deviated from not only the part of the exterior container corresponding to the sealing plate 1b but also from the part of the exterior container corresponding to the current cutoff element 37. In this case, it is possible to avoid that an excess press force is applied to the current cutoff element 37, which in turn causes misoperation in the current cutoff element 37.

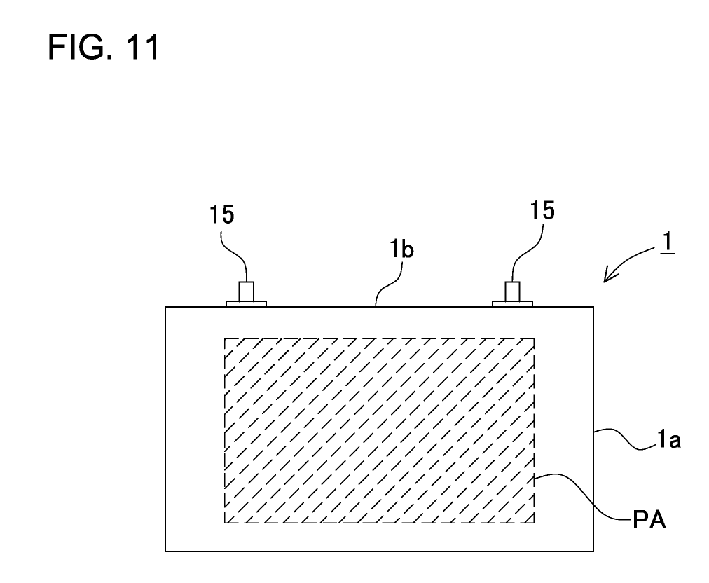

It is more preferable that, as shown in the cross-sectional view of FIG. 10B and the plan view of FIG. 11, the battery press area PA of the spacer 2 overlap the part of the exterior container 1a the interior surface of which is in contact with the wound electrode 34, in other words, the part of the exterior container 1a corresponding to the flat part of the surfaces of the wound electrode 34. According to this construction, the wound electrode 34 can be reliably held, while it is possible to reduce a stress that is applied to members (e.g., exterior container 1a, etc.) of the battery cell 1a other than the wound electrode 34. Therefore, it is possible to improve the reliability.

Here, the relationship is now considered between the outer thickness of the wound electrode 34 and the opening width of the exterior container 1a. When the wound electrode 34 is inserted into the exterior container 1a as shown in FIG. 3, etc., in the case where the thickness of the wound electrode is smaller than the opening width of the exterior container, the exterior container can be easily inserted the exterior container 1a. For this reason, from viewpoint of assembling workability, it is preferable that the thickness of the wound electrode be smaller than the opening width of the exterior container. On the other hand, if the thickness of the wound electrode is smaller than the opening width of the exterior container, gaps are formed between the surface of the wound electrode and the interior surface of the exterior container. Accordingly, as shown in FIG. 10A, the wound electrode 34 will be suspended by the current-collector-connecting portions 36 inside the exterior container 1a. Particularly, in recent years, to satisfy requirement for higher power, wound electrodes are formed of a large number of turns of wound sheets. As a result, the weight of these wound electrodes becomes heavier. In particular, in the case where heavy wound electrodes are used in vehicle power supply devices, when the battery cells are subjected to vibration, a large stress will be applied to the current-collector-connecting portions, the holding parts between the current-collector-connecting portion and the sealing plate, and the like. As a result, stress will be applied for a long time to the current-collector-connecting portions, and the holding parts between the current-collector-connecting portion and the sealing plate. Also, the power supply devices are produced on a site different from the battery cells in some cases. In such a case, it is necessary to transport the battery cells to the manufacturing site for power supply devices. For this reason, during transportation, a large stress may be applied to the current-collector-connecting portions, the holding parts between the current-collector-connecting portion and the sealing plate, and the like.

However, if the gap between the surface of the wound electrode and the interior surface of the exterior container is eliminated, the electrically insulating cover may be damaged by the edge of the opening of the exterior container. Correspondingly, it will be difficult for workers to insert the wound electrodes into the exterior containers. Accordingly, the workers are required to carefully insert the wound electrodes into the exterior containers so as to prevent the electrically insulating cover from being damaged. As a result, the workability decreases.

To address this, as shown in FIGS. 10A to 10B, in this embodiment, the thickness of the wound electrode 34 is set smaller than the opening width of the exterior container 1a when the wound electrode 34 is inserted into the exterior container 1a, while the external surface of the wound electrode 34 contact is brought into contact with the interior surface of the exterior container 1a when the battery block is securely held by the fastening members. Even in the case where the exterior container 1a is formed of metal, the exterior container 1a can be deformed by a certain small amount by adjusting a fastening force of the fastening members. The wound electrode 34 can be brought into contact with the exterior container 1a by using this deformation of the exterior container 1a so that the both flat surface sides of the wound electrode 34 can be interposed between the interior surfaces of the exterior container 1a. As a result, the wound electrode 34 can be stably held. According to this construction, it is possible to improve the workability when the battery cell is assembled. In addition to this, since the battery cells are pressed by the fastening members, the wound electrode can be held by the interior surfaces of the exterior container. On the other hand, if the wound electrode is suspended and movable inside the exterior container, when the battery cell is subjected to shock and vibration from the outside, the wound electrode may collide with the interior surface of the exterior container and other members. However, according to the present invention, since the wound electrode is held by the exterior container as discussed above, it is possible to solve this problem. Therefore, it is possible to improve the reliability.

In addition, the wound electrode surface can be brought into contact with the exterior container interior surfaces by expansion of the wound electrode after the wound electrode is inserted into the exterior container not by forcedly deforming the exterior container by using the fastening members. For example, the wound electrode can expand in accordance with charged state or battery performance change. The wound electrode can be held between the exterior container interior surfaces by using this thickness increase of the wound electrode.

Typically, in order to prevent that the battery cell is over-discharged/over-charged, discharge and charge limit voltages are previously defined. The battery can be used in the range from the discharge limit voltage to the charge limit voltage. The charge rate (SOC) is defined as a battery capacity relative to the full charge capacity (battery capacity corresponding to the charge limit voltage). The battery cell can be charged/discharged in the SOC range of 0% to 100%. In a typical case, in order to suppresses reduction of the life of the battery cell, the battery cell is used not in the SOC range of 0% to 100%, but in a certain limited range. The present invention particularly relates to a large power supply device. In particular, in the case of a large power supply device, long life is required. For this reason, a SOC limited range is typically defined in the case of a large power supply device. For example, in the case of a hybrid car (HEV) that uses both an electric motor and an internal-combustion engine for vehicle travelling, the SOC limited range is typically set to the range of about 40% to 60%. For example, in the case of an electric vehicle (EV), the SOC limited range is typically set to the range of 20% to 80%.

In the case where the SOC limited range is set, the battery cell can be designed so that the wound electrode can come in contact with the exterior container within this SOC limited range. For example, in the case where the battery cell is used within the SOC limited range of 20% to 80%, the battery cell is designed so that the wound electrode cannot come in contact with the exterior container at the SOC of about 0%, but can come in contact with the exterior container when the SOC reaches 20%. According to this construction, since the wound electrode will not be in contact with the exterior container in the assembling process, the wound electrode can be easily inserted into the exterior container. Also, since the wound electrode will be in contact with the exterior container when the power supply device is used, it is possible to reduce a stress that is applied to the current-collector-connecting portions, which hold the wound electrode.

Similarly, battery performance change can be used. Specifically, although the size of the wound electrode varies in accordance with SOC, the wound electrode has the property that the size of the wound electrode will increase as the battery cell deteriorates even if the battery cell has the same SOC. In other words, the wound electrode will expand in accordance with the battery deterioration independent of the SOC. In other words, the wound electrode will expand in accordance with the battery deterioration independent of the SOC. In the case where this property is used, the battery cell is designed so that the wound electrode can be brought into contact with the exterior container by expansion of the wound electrode after the battery cell is charged/discharged at least one time, preferably two to five times, before the power supply device is assembled by arranging the battery cells side by side. According to this construction, similar to the aforementioned construction, since the wound electrode will not be in contact with the exterior container in the assembling process, the wound electrode can be easily inserted into the exterior container. Also, since the wound electrode will be in contact with the exterior container when the power supply device is used, it is possible to reduce a stress that is applied to the current-collector-connecting portions, which hold the wound electrode.

Production facilities for producing the battery cell and the power supply device are relatively large. For this reason, the battery cell and the power supply device are produced on different sites in some cases. Accordingly, the battery cell is often stored for several days after the battery cell is produced until the power supply device is assembled. In such a case, the battery cell may be over-discharged due to self-discharging. To avoid this, the battery cell is stored after previously charged to about SOC of 5% to 30%, for example. The battery cell can be designed so that the wound electrode can come in contact with the exterior container when the battery cell is previously charged to this SOC.

Various factors vary the expansion amount of the wound electrode in accordance with charging/discharging operation, and the expansion amount of the wound electrode in accordance with battery deterioration as the battery cells repeatedly charged/discharged. For example, these expansion amounts can be varied by the composition of an active material layer applied on the positive/negative electrode sheets 34a of the wound electrode. Specifically, as the application amount of the active material layer is increased, the capacity of the battery can be increased, while the amount of the metal ions will be also increased which come into the active material layer so that the wound electrode is likely to expand.

The assembling processes of the battery cell and the power supply device are now described.

1) The exterior container 1a that opens on one face is formed by subjecting an aluminum plate to deep drawing.

2) The sealing plate 1b is formed by subjecting an aluminum plate to forging. Also, openings are formed on the sealing plate 1b. The openings are the opening of the safety valve 12, and the openings for receiving the electrode terminals 15. The safety valve 12 can open if the internal pressure of the battery cell 1 rises.

3) The current-collector-connecting portions 36, and the electrode terminals 15 are attached to the sealing plate 1b with gaskets (not shown) being interposed between them. The electrode terminals 15 are electrically connected to the current-collector-connecting portions 36. The current-collector-connecting portions 36 and the electrode terminals 15 are electrically insulated from the sealing plate 1b by the gaskets.

4) The positive and negative electrode sheets 34a, and the porous electrically insulating separator sheets 34b are wound and formed into a cylindrical wound member (not shown). The active material layer is previously applied onto the electrode sheet. Specifically, the wound member includes the positive and negative electrode sheets 34a, and two the separator sheets 34b. The separator sheets 34b are interposed between the positive electrode sheet 34a and the negative electrode sheet 34a after these sheets are wound.

5) The cylindrical wound member is pressed from both sides so that the wound electrode 34, which has a flat elliptic cylindrical shape, is formed. The wound electrode 34 is compressed and deformed so that the thickness of the wound electrode 34 is smaller than the opening width of the opening of the exterior container 1a.

6) The current-collecting tabs 35 as the current collectors are arranged on the both sides of the wound electrode 34. The current-collecting tabs 35 are welded and fastened to the current-collector-connecting portions 36 by resistance welding so that the wound electrode 34 is suspended from the sealing plate 1b.

7) The wound electrode 34 is inserted through the opening of the exterior container 1a into the exterior container 1a. The sealing plate 1b is welded to the exterior container 1a so that the wound electrode 34 is enclosed in the exterior container 1a. The current-collector-connecting portions 36 hold the wound electrode 34 so that the wound electrode 34 is spaced from the bottom interior surface of the exterior container 1a. According to this construction, even if the dimensional deviation of the wound electrode 34 and the current-collector-connecting portions 36 is relatively large, it is possible to prevent that the exterior container 1a may not physically interfere with the wound electrode 34 when the wound electrode 34 is inserted through the opening of the exterior container 1a into the exterior container 1a. Accordingly, since the sealing plate 1b can be brought in tight contact with the exterior container 1a when the sealing plate 1b is welded to the exterior container 1a, it is possible to reduce the occurrence of poor welding connection.

8) The sealing plate 1b has an injection hole (not shown). The electrolyte is injected into the exterior container 1a, which accommodates the wound electrode 34. After the electrolyte is injected into the exterior container 1a, the wound electrode 34 is impregnated with the electrolyte. Thus, the electrolyte can be interposed between the positive and negative electrode sheets 34a of the wound electrode 34 after a certain lapse of time. The wound electrode 34 is not immediately impregnated with the electrolyte. For this reason, a fraction of the required amount of electrolyte is injected for several times if necessary.

9) After the exterior container accommodates power generation elements such as the electrolyte and the wound electrode 34, the battery cell is subjected to inspections. Thus, the battery cell 1 is produced. The battery cell 1 is previously charged and stored, in order to prevent that the battery cell 1 is over-discharged. The battery cell 1 according to the aforementioned embodiment is constructed so that the wound electrode 34 is in contact with the exterior container 1a after the battery cell 1 is previously charged. According to this construction, it is possible to prevent that a stress is locally applied to the current-collector-connecting portions 36, which suspend the wound electrode 34, when the battery cell 1 is subjected to vibration during transportation.

10) The transported battery cells 1 are arranged side by side. Thus, the battery block 10 is formed. The end plates 4 are arranged on the both end surfaces of the battery block 10. The battery block 10 is pressed in the side-by-side arrangement direction of the battery cells by an assembly jig. The bind bars 5 straddle the pressed battery block 10, and are fastened to the end plates 4. The assembly jig is removed after the bind bars 5 are fastened to the end plates 4.

The power supply device is assembled by the aforementioned processes. In the thus-assembled power supply device, since, after the wound electrodes 34 is brought into contact with the exterior containers 1a, these exterior container 1a, which enclose the wound electrodes 34, are securely held by the fastening members, the wound electrode 34 can be securely interposed between the interior surfaces of the exterior containers 1a. According to this construction, the wound electrode 34 can be more securely held between the interior surfaces of the exterior containers by the bind bars 5, even when a relatively large stress is applied to the battery cell or the power supply device, it is possible to prevent that the stress is locally applied to the current-collector-connecting portions, or the holding parts between the current-collector-connecting portion and the sealing plate.

The aforementioned power supply devices can be used as a battery system for vehicles. The power supply device can be installed on electric vehicles such as hybrid cars that are driven by both an engine and a motor, and electric vehicles that are driven only by a motor. The power supply device can be used as a power supply device for these types of vehicles.

### (Hybrid Car Power Supply Device)

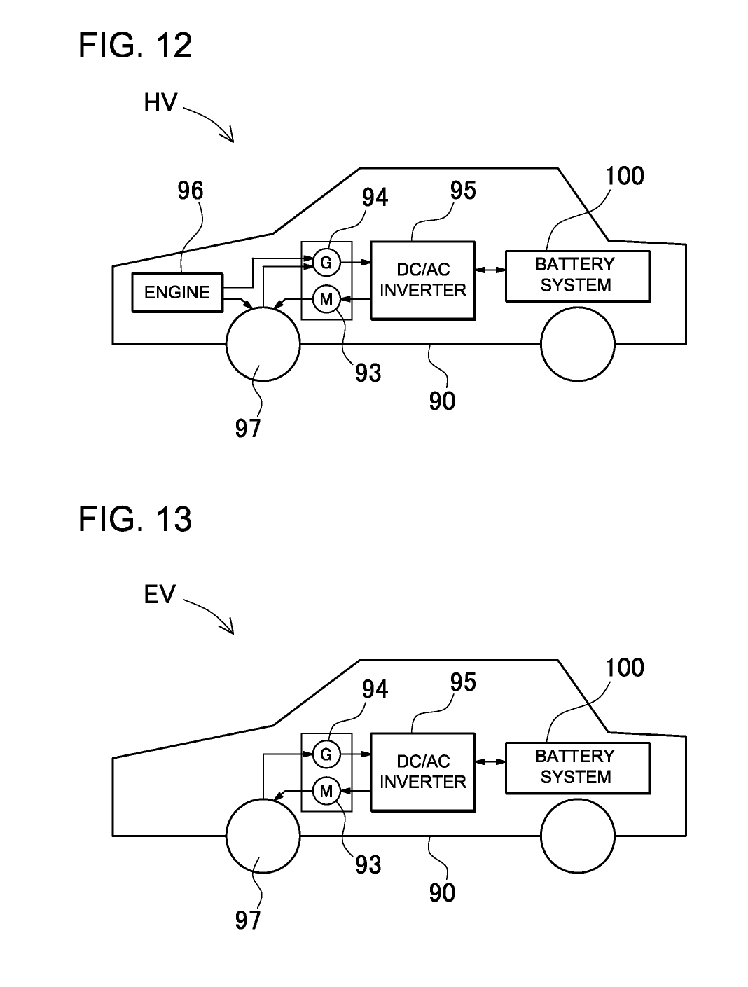

FIG. 12 is a block diagram showing an exemplary hybrid car that is driven both by an engine and an electric motor, and includes the power supply device. The illustrated vehicle HV including the power supply device includes an electric motor 93, an internal-combustion engine 96, the power supply device 100, an electric generator 94, a vehicle body 90, and wheels 97. The electric motor 93 and the internal-combustion engine 96 drive the vehicle HV. The power supply device 100 supplies electric power to the electric motor 93. The electric generator 94 charges battery cells of the power supply device 100. The vehicle body 90 accommodates the internal-combustion engine 96, the electric motor 93, the power supply device 100, and the electric generator 94. The wheels 97 are driven for vehicle body 90 travelling by the internal-combustion engine 96 or the electric motor 93. The power supply device 100 is connected to the electric motor 93 and the electric generator 94 via a DC/AC inverter 95. The vehicle HV is driven both by the electric motor 93 and the internal-combustion engine 96 with the battery cells of the power supply device 100 being charged/discharged. The electric motor 93 is energized with electric power and drives the vehicle in a poor engine efficiency range, e.g., in acceleration or in a low speed range. The electric motor 93 is energized by electric power that is supplied from the power supply device 100. The electric generator 94 is driven by the engine 96 or by regenerative braking when users brake the vehicle so that the battery cells of the power supply device 100 are charged.

### (Electric Vehicle Power Supply Device)

FIG. 13 shows an exemplary electric vehicle that is driven only by an electric motor, and includes the power supply device. The illustrated vehicle EV including the power supply device includes the electric motor 93, the power supply device 100, the electric generator 94, the vehicle body 90, and wheels 97. The electric motor 93 drives the vehicle EV. The power supply device 100 supplies electric power to the electric motor 93. The electric generator 94 charges battery cells of the power supply device 100. The vehicle body 90 accommodates the electric motor 93, the power supply device 100, and the electric generator 94. The wheels 97 are driven for vehicle body 90 travelling by the electric motor 93. The power supply device 100 is connected to the electric motor 93 and the electric generator 94 via a DC/AC inverter 95. The electric motor 93 is energized by electric power that is supplied from the power supply device 100. The electric generator 94 can be driven by vehicle EV regenerative braking so that the battery cells 20 of the power supply device 100 are charged.

### (Power Storage Type Power Supply Device)

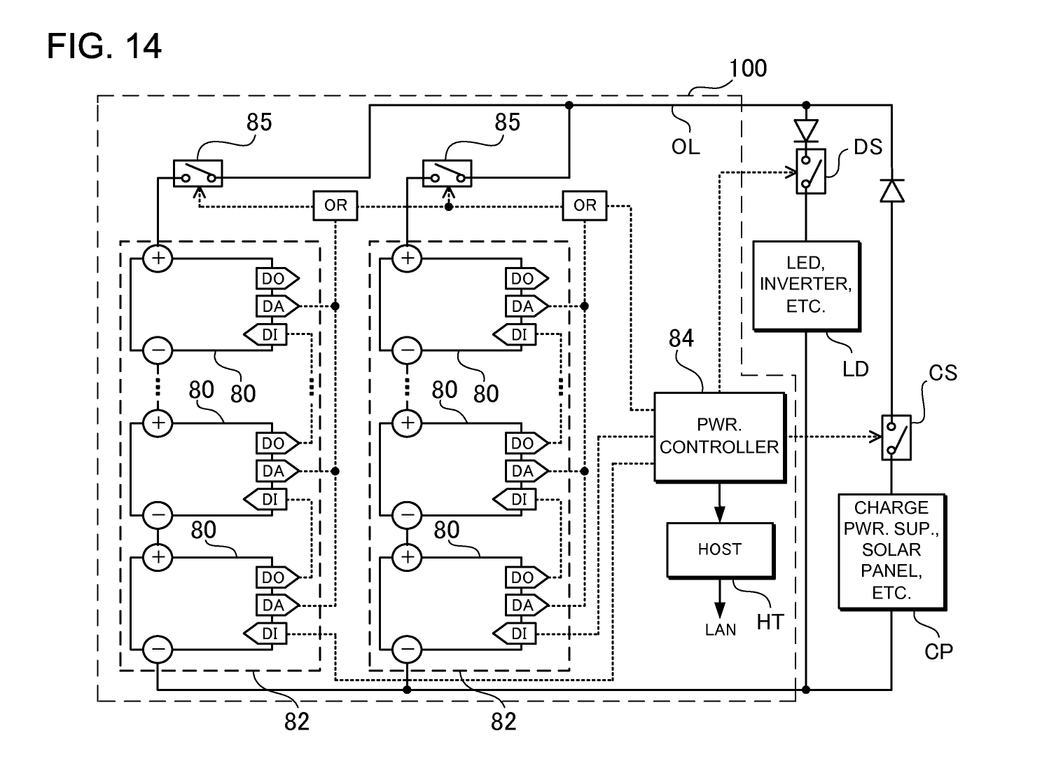

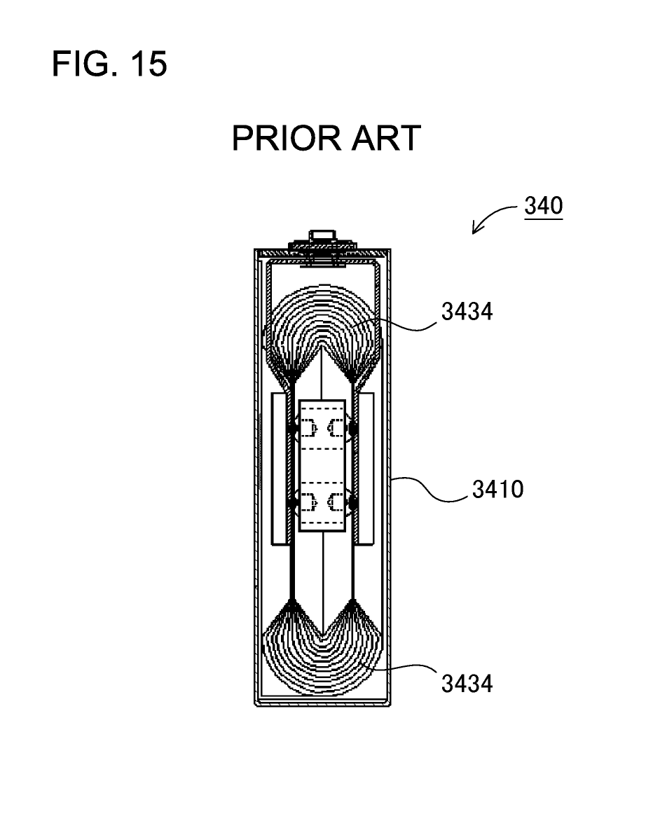

The power supply device can be used not only as power supply of mobile unit but also as stationary power storage. For example, examples of stationary power storage devices can be provided by an electric power system for home use or plant use that is charged with sunlight or with midnight electric power and is discharged when necessary, a power supply for street lights that is charged with sunlight during the daytime and is discharged during the nighttime, or a backup power supply for signal lights that drives signal lights in the event of a power failure. FIG. 14 shows an exemplary circuit diagram. This illustrated power supply device 100 includes battery units 82 each of which includes a plurality of battery blocks 80 that are connected to each other. In each of battery blocks 80, a plurality of battery cells 1′ are connected to each other in serial and/or in parallel. The battery blocks 80 are controlled by a power supply controller 84. In this power supply device 100, after the battery units 82 are charged by a charging power supply CP, the power supply device 100 drives a load LD. The power supply device 100 has a charging mode and a discharging mode. The Load LD and the charging power supply CP are connected to the power supply device 100 through a discharging switch DS and a charging switch CS, respectively. The discharging switch DS and the charging operation switch CS are turned ON/OFF by the power supply controller 84 of the power supply device 100. In the charging mode, the power supply controller 84 turns the charging operation switch CS ON, and turns the discharging switch DS OFF so that the power supply device 100 can be charged by the charging power supply CP. When the charging operation is completed so that the battery units are fully charged or when the battery units are charged to a capacity not lower than a predetermined value, if the load LD requests electric power, the power supply controller 84 turns the charging operation switch CS OFF, and turns the discharging switch DS ON. Thus, operation is switched from the charging mode to the discharging mode so that the power supply device 100 can be discharged to supply power to the load LD. In addition, if necessary, the charging operation switch CS may be turned ON, while the discharging switch DS may be turned ON so that the load LD can be supplied with electric power while the power supply device 100 can be charged.

The load LD driven by the power supply device 100 is connected to the power supply device 100 through the discharging switch DS. In the discharging mode of the power supply device 100, the power supply controller 84 turns the discharging switch DS ON so that the power supply device 100 is connected to the load LD. Thus, the load LD is driven with electric power from the power supply device 100. Switching elements such as FET can be used as the discharging switch DS. The discharging switch DS is turned ON/OFF by the power supply controller 84 of the power supply device 100. The power supply controller 84 includes a communication interface for communicating with an external device. In the exemplary power supply device shown in FIG. 14, the power supply controller is connected to a host device HT based on existing communications protocols such as UART and RS-232C. Also, the power supply device may include a user interface that allows users to operate the electric power system if necessary.

Each of the battery blocks 80 includes signal terminals and power supply terminals. The signal terminals include an input/output terminal DI, an abnormality output terminal DA, and a connection terminal DO. The block input/output terminal DI serves as a terminal for providing/receiving signals to/from other battery blocks 80 and the power supply controller 84. The block connection terminal DO serves as a terminal for providing/receiving signals to/from other battery blocks 80. The abnormality output terminal DA serves as a terminal for providing an abnormality signal of the battery block 80 to the outside. Also, the power supply terminal is a terminal for connecting one of the battery blocks 80 to another battery blocks in series or in parallel. In addition, the battery units 82 are connected to an output line OL through parallel connection switches 85, and are connected in parallel to each other.

### INDUSTRIAL APPLICABILITY

A power supply device according to the present invention can be suitably used as power supply devices of plug-in hybrid vehicles and hybrid electric vehicles that can switch between the EV drive mode and the HEV drive mode, electric vehicles, and the like. A battery cell according to the present invention can be suitably used for power supply devices of plug-in hybrid vehicles and hybrid electric vehicles. A vehicle and electric power storage device including this power supply device according to the present invention can be suitably used as plug-in hybrid vehicles, hybrid electric vehicles, electric vehicles, and the like. Also, a power supply device according to the present invention can be suitably used as backup power supply devices that can be installed on a rack of a computer server, backup power supply devices for wireless communication base stations, electric power storages for home use or plant use, electric power storage devices such as electric power storages for street lights connected to solar cells, backup power supplies for signal lights, and the like.

It should be apparent to those with an ordinary skill in the art that while various preferred embodiments of the invention have been shown and described, it is contemplated that the invention is not limited to the particular embodiments disclosed, which are deemed to be merely illustrative of the inventive concepts and should not be interpreted as limiting the scope of the invention, and which are suitable for all modifications and changes falling within the scope of the invention as defined in the appended claims.

What is claimed is:

1. A power supply device comprising a battery block that includes a plurality of battery cells, and a fastening member that securely holds said battery block,
wherein each of said battery cells comprises:
an exterior container that has a rectangular exterior shape, and opens on at least one face;
a wound electrode including electrode and separator sheets that are wound so that the electrode and separator sheets are alternately superposed on each other;
a sealing plate that closes the opening of said exterior container with the wound electrode being accommodated in this exterior container; and
a current-collector-connecting portion that is fastened to said sealing plate and electrically connected to said wound electrode,
wherein said wound electrode has a thickness smaller than the opening width of said exterior container so that said wound electrode can be inserted into said exterior container,
wherein said current-collector-connecting portion suspends said wound electrode so that the bottom side of said wound electrode is spaced away from the bottom interior surface of said exterior container, and
wherein said fastening member securely holds said battery block so that the wound electrodes, which are accommodated in the exterior containers, are interposed between the interior surfaces of the exterior containers of the battery cells.

2. The power supply device according to claim 1,
wherein said battery cell includes an electrically insulating cover that is arranged between said wound electrode and said exterior container, and formed from an electrically insulating film, and
wherein said fastening member securely holds said battery block so that said electrically insulating covers come in contact with said wound electrode contacts.

3. The power supply device according to claim 1,
wherein current-collecting tabs are provided on the both sides of said wound electrode,
wherein said current-collecting tabs are fastened to current-collector-connecting portions as said current-collector-connecting portion so that said wound electrode is suspended, and
wherein said current-collector-connecting portion is orientated in parallel to the main surface of said exterior container.

4. The power supply device according to claim 1, wherein said wound electrode can expand and come in direct or indirect contact with the interior surface of said exterior container after said battery cell is repeatedly charged/discharged.

5. The power supply device according to claim 1 further comprising a spacer that is interposed between said battery cells so that said battery cells are pressed by the spacers, wherein this battery press area of each of the spacers overlaps the part of said battery cell where said wound electrode is arranged.

6. The power supply device according to claim 1 further comprising a spacer that is interposed between said battery cells, wherein said spacer does not overlap the part of said battery cell where said sealing plate is arranged.

7. The power supply device according to claim 1,
wherein each of battery cells includes a current cutoff element that cuts off the output current if an abnormality occurs inside said exterior container,
wherein said current cutoff element is arranged inside said exterior container between said sealing plate and said wound electrode, and
wherein the power supply device further comprises a spacer that is interposed between said battery cells, wherein said spacer does not overlap the part of said battery cell where said current cutoff element is arranged.

8. A method for producing a power supply device including a battery block that includes a plurality of battery cells, and a fastening member that securely holds said battery block, the method comprising:
forming an exterior container that has a rectangular exterior shape, and opens on at least one face;
forming a wound electrode including electrode and separator sheets to be wound so that the electrode and separator sheets are alternately superposed on each other;
forming a sealing plate to hold current-collector-connecting portions to be electrically connected to said wound electrode;
winding said wound electrode so that said wound electrode has a thickness smaller than the opening width of said exterior container;
fastening said current-collector-connecting portions onto current-collecting tabs that are provided on the both sides of said wound electrode;
inserting said wound electrode into said exterior container through the opening of said exterior container, and suspending said wound electrode from said the sealing plate so that the bottom side of said wound electrode is spaced away from the bottom interior surface of said exterior container;
injecting an electrolyte into said exterior container so that the battery cell is produced;
charging the produced battery cell to a predetermined SOC so that the external surface of said wound electrode comes in direct or indirect contact with the interior surface of said exterior container; and
securely holding said battery block by said fastening member so that the wound electrodes are interposed between the interior surfaces of the exterior containers.

9. A battery cell that is charged to a predetermined SOC whereby preventing this battery cell from being over-discharged during storage, the battery cell comprising:
an exterior container that has a rectangular exterior shape, and opens on at least one face;
a wound electrode including electrode and separator sheets that are wound so that the electrode and separator sheets are alternately superposed on each other;
a sealing plate that closes the opening of said exterior container with the wound electrode being accommodated in this exterior container; and
a current-collector-connecting portion that is fastened to said sealing plate and electrically connected to said wound electrode,
wherein said wound electrode has a thickness smaller than the opening width of said exterior container so that said wound electrode can be inserted into said exterior container,
wherein said current-collector-connecting portion suspends said wound electrode so that the bottom side of said wound electrode is spaced away from the bottom interior surface of said exterior container, and
wherein the external surface of said wound electrode is brought in indirect contact with the interior surface of said exterior container with an electrically insulating cover being interposed between the interior surface of said exterior container and the external surface of said wound electrode after the battery cell is charged to the predetermined SOC.

10. A vehicle comprising the power supply device according to claim 1, wherein the vehicle further comprises:
a driving electric motor that is supplied with the electric power from said power supply device;
a vehicle body that accommodates said power supply device and said electric motor; and
wheels that are driven by said electric motor for vehicle traveling.

11. An electric power storage device comprising the power supply device according to claim 1, the electric power storage device further comprising:
a power supply controller that controls charging/discharging operation of said power supply device,
said power supply device can be charged with electric power from the outside by said power supply controller, wherein said power supply device controls charging operation of said power supply device when said power supply device is charged with electric power from the outside.
